(19) United States
(12) Patent Application Publication
(10) Pub. No.: US 2024/0290096 A1
(43) Pub. Date: Aug. 29, 2024

(54) VIDEO FRAME FEATURE EXTRACTION METHOD, DEVICE AND COMPUTER-READABLE STORAGE MEDIUM

(71) Applicant: UBTECH ROBOTICS CORP LTD, Shenzhen (CN)

(72) Inventors: Kan Wang, Shenzhen (CN); Shuping Hu, Shenzhen (CN); Jianxin Pang, Shenzhen (CN); Huan Tan, Shenzhen (CN)

(21) Appl. No.: 18/422,046

(22) Filed: Jan. 25, 2024

(30) Foreign Application Priority Data
Feb. 28, 2023 (CN) 202310227995.4

(51) Int. Cl. G06V 20/40; G06V 10/77; G06V 10/80

(52) U.S. Cl. CPC G06V 20/46; G06V 10/7715; G06V 10/806

(57) ABSTRACT

A method for extracting video frame features includes: obtaining a number of initial features of each video frame in a video sequence; calculating global channel attention information of the video sequence based on the initial features of each video frame in the video sequence; calculating local channel attention information of a target video frame according to initial features of a target video frame; wherein the target video frame is one of the video frames in the video sequence; and performing channel attention mechanism processing on the initial features of the target video frame according to the global channel attention information and the local channel attention information to obtain optimized features of the target video frame.

### CROSS-REFERENCE TO RELATED APPLICATIONS

This application claims priority to Chinese Patent Application No. CN 202310227995.4, filed Feb. 28, 2023, which is hereby incorporated by reference herein as if set forth in its entirety.

### TECHNICAL FIELD

The present disclosure generally relates to video recognition, and in particular relates to a video frame feature extraction method, device and computer-readable storage medium.

### BACKGROUND

When performing video learning tasks, it is usually necessary to perform video frame extraction from the video frames in a video sequence in order to use the feature information of the video frames to perform video learning tasks on the video sequence. With the development of artificial intelligence technology, various types of videos are becoming more and more abundant, and video learning tasks are becoming increasingly complex. The accurate extraction of video frame features becomes particularly important.

However, some conventional methods for extracting video frame features can only capture local features of individual video frames, resulting in poor robustness of the video frame feature extraction.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of a device according to one embodiment.

FIG. 2 is an exemplary flowchart of a video frame feature extraction method according to one embodiment.

FIG. 3 is an exemplary flowchart of global channel attention information calculation according to one embodiment.

FIG. 4 is a schematic diagram of video frame feature extraction according to one embodiment.

FIG. 5 is a schematic flowchart of local channel attention information calculation according to one embodiment.

FIG. 6 is a schematic block diagram of a video frame feature extraction device according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

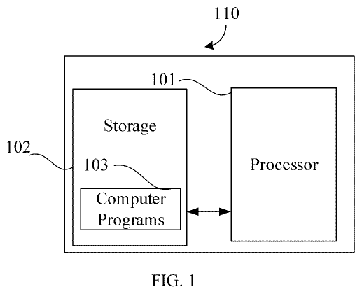

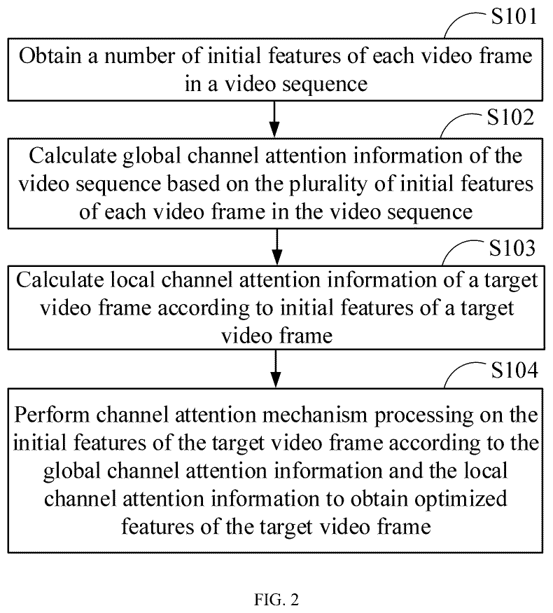

FIG. 1 shows a schematic block diagram of a device 110 according to one embodiment. The device 110 may include a processor 101, a storage 102, and one or more executable computer programs 103 that are stored in the storage 102. The storage 102 and the processor 101 are directly or indirectly electrically connected to each other to realize data transmission or interaction. For example, they can be electrically connected to each other through one or more communication buses or signal lines. The processor 101 performs corresponding operations by executing the executable computer programs 103 stored in the storage 102. When the processor 101 executes the computer programs 103, the steps in the embodiments of a video frame feature extraction method, such as steps S101 to S104 in FIG. 2 are implemented.

The processor 101 may be an integrated circuit chip with signal processing capability. The processor 101 may be a central processing unit (CPU), a general-purpose processor, a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 101 can implement or execute the methods, steps, and logical blocks disclosed in the embodiments of the present disclosure.

The storage 102 may be, but not limited to, a random-access memory (RAM), a read only memory (ROM), a programmable read only memory (PROM), an erasable programmable read-only memory (EPROM), and an electrical erasable programmable read-only memory (EEPROM). The storage 102 may be an internal storage unit of the device 110, such as a hard disk or a memory. The storage 102 may also be an external storage device of the device 110, such as a plug-in hard disk, a smart memory card (SMC), and a secure digital (SD) card, or any suitable flash cards. Furthermore, the storage 102 may also include both an internal storage unit and an external storage device. The storage 102 is to store computer programs, other programs, and data required by the device 110. The storage 102 can also be used to temporarily store data that have been output or is about to be output.

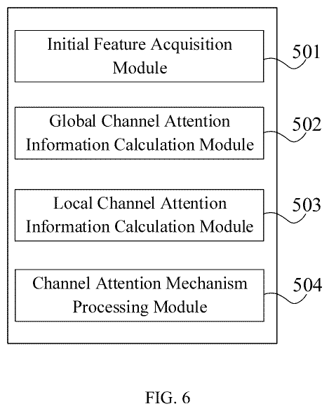

Exemplarily, the one or more computer programs 103 may be divided into one or more modules/units, and the one or more modules/units are stored in the storage 102 and executable by the processor 101. The one or more modules/units may be a series of computer program instruction segments capable of performing specific functions, and the instruction segments are used to describe the execution process of the one or more computer programs 103 in the device 110. For example, the one or more computer programs 103 may be divided into an initial feature acquisition module 501, a global channel attention information calculation module 502, a local channel attention information calculation module 503, and a channel attention mechanism processing module 504 as shown in FIG. 6.

It should be noted that the block diagram shown in FIG. 1 is only an example of the device 110. The device 110 may include more or fewer components than what is shown in FIG. 1, or have a different configuration than what is shown in FIG. 1. Each component shown in FIG. 1 may be implemented in hardware, software, or a combination thereof.

FIG. 2 is an exemplary flowchart of a video frame feature extraction method according to one embodiment. As an example, but not a limitation, the method can be implemented by the device 110. The method may include the following steps.
Step S101: Obtain a number of initial features of each video frame in a video sequence.

In one embodiment, the initial features of each video frame in the video sequence can be obtained, and the global channel attention information of the video sequence is determined based on the initial features of each video frame.

In one embodiment, the video sequence can be stored in a preset location, for example, in a memory module of a terminal device or a cloud server. When it needs to obtain a video sequence, the video sequence can be obtained directly from the memory module of the terminal device, or the video sequence can be obtained by sending a video sequence acquisition request to the cloud server and parsing the response message returned by the cloud server.

In one embodiment, the video sequence can be captured in real time according to a video sequence capturing instruction of the terminal device.

It can be understood that in order to improve the efficiency of video frame feature extraction, before determining the global channel attention information, preliminary feature extraction can be performed on the video frames {I₁, I₂, I₃, . . . , I_{T}} in the video sequence to obtain the necessary feature information. After that, higher-precision video frame feature extraction or channel attention mechanism processing and other subsequent operations are performed based on the obtained initial features {F₁, F₂, F₃, . . . , F_{T}} of each video frame.

In one embodiment, the backbone network Backbone can be employed to perform preliminary feature extraction on each video frame in the video sequence to obtain the initial features of each video frame. The backbone network Backbone can be a preset deep neural network used for video frame feature extraction. For example, it can be a Convolutional Neural Network (CNN) or a Recurrent Neural Network (RNN), which are commonly used deep neural networks for feature extraction in conventional technologies.

It should be noted that since the video sequence includes multiple video frames, each of which is an image, the initial features of the video frames can be in the form of corresponding feature maps.
Step S102: Calculate global channel attention information of the video sequence based on the plurality of initial features of each video frame in the video sequence.

It is understandable that if only the local feature information of a single video frame is extracted, the impact of timing (frames before and after the video frame) on the video frame tends to be ignored, resulting in insufficiency of the extracted video frame features. Therefore, in one embodiment of the present disclosure, global channel attention information obtained from the video sequence can be calculated based on the initial features of each video frame in the video sequence. By fusing global channel attention information and local channel attention information, a complete and sufficient expression of video frame features can be achieved.

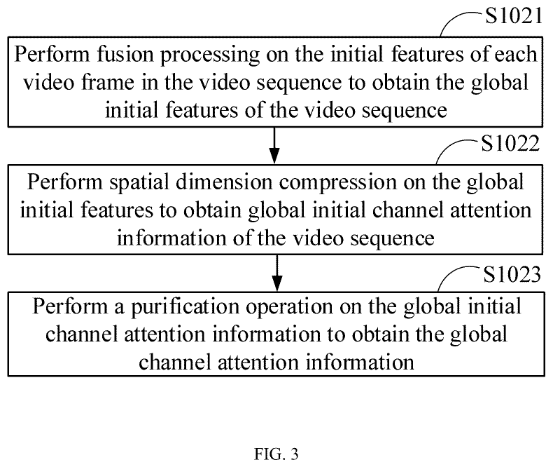

Referring to FIG. 3, in one embodiment, step S102 may include the following steps.
Step S1021: Perform fusion processing on the initial features of each video frame in the video sequence to obtain the global initial features of the video sequence.

In one embodiment, the global initial features of the video sequence can be obtained by performing fusion processing on the initial features of each video frame in the video sequence, and effectively correlating each video frame in the video sequence.

Specifically, the initial features of each video frame can be averaged to obtain the global initial features of the video sequence according to the following equation:

$${F}^{global} = \frac{1}{T} {\sum }_{t = 1}^{T} {F}_{t} ,$$

where F^{global} represents the global initial features of the video sequence, Tis the number of video frames in the video sequence, and Fₜ is the initial feature of the t-th video frame Iₜ.
Step S1022: Perform spatial dimension compression on the global initial features to obtain global initial channel attention information of the video sequence.

In one embodiment, spatial dimension compression can be performed on the global initial features to obtain global initial channel attention information of the video sequence.

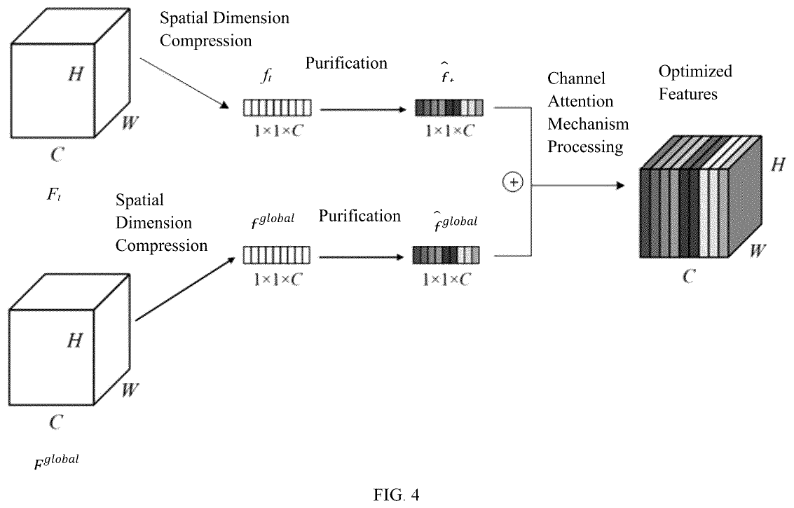

The dimension of the global initial feature F^{global} can be expressed as H×W×C. H, where W and C represent the height, width and number of feature channels of the global initial feature F^{global} respectively. For each feature channel, its corresponding two-dimensional feature with a dimension of H×W can be obtained. Therefore, in one embodiment, the H×W two-dimensional feature corresponding to each feature channel in the global initial feature F^{global} can be obtained first. After that, spatial dimension compression is performed on the H×W two-dimensional features corresponding to the feature channels to obtain the corresponding 1×1 two-dimensional features. Based on this, the global initial channel attention information f^{global} with a dimension of 1×1×C as shown in FIG. 4 can be obtained.

Specifically, a global average pooling operation can be performed on the obtained global initial features to obtain the global initial channel attention information f^{global}. In one embodiment, the global average pooling operation can be expressed by the following equation:

$${f}^{global} = \frac{1}{H \times W} {\sum }_{h = 1}^{H} {\sum }_{w = 1}^{W} {F}_{h , w}^{global} ,$$

where f^{global} represents the global initial channel attention information, and F_{h,w}^{global} represents the two-dimensional features corresponding to the feature channels.

According to the equation, the feature information of the global initial features on each feature channel can be obtained, and based on this, the global initial channel attention can be obtained.
Step S1023: Perform a purification operation on the global initial channel attention information to obtain the global channel attention information.

It is understandable that in practical applications, not all feature information on feature channels is the feature information of interest. In order to reduce the interference of irrelevant feature information, the global initial channel attention information can be purified. Then, the importance of feature information on each feature channel in the global initial channel attention information is predicted, and the global channel attention information is obtained.

In one embodiment, two fully connected layers can be employed to purify the global initial channel attention information, construct the correlation between feature channels, and obtain the global channel attention information.

Specifically, a preset first fully connected layer for purifying the global initial channel attention information can be employed to perform dimensionality reduction processing on the global initial channel attention information to obtain global dimensionality reduction channel attention information. After that, a preset second fully connected layer for purifying the global initial channel attention information is employed to perform dimensionality enhancement processing on the global dimensionality reduction channel attention information to obtain the global channel attention information. In one embodiment, the purification operation in the embodiment can be expressed by the following equation: \hat{f}^{global}=W₂^{global}(W₁^{global} f^{global}), where \hat{f}^{global} represents the global channel attention information, W₁^{global} represents the first purification coefficient of the global initial channel attention information, W₂^{global} represents the second purification coefficient of the global initial channel attention information, W₁^{global} and W₂^{global} respectively represent the dimensionality reduction and dimensionality enhancement of the global initial channel attention information f^{global}.

In one embodiment, after the fully connected layer, a preset activation function can also be employed to activate the obtained channel attention information. For example, a preset first activation function can be employed after the first fully connected layer, and a preset second activation function can also be employed after the second fully connected layer. The activation function can be set according to actual needs. For example, it can be a common activation function such as a Sigmoid activation function or a Swish activation function.
Step S103: Calculate local channel attention information of a target video frame according to initial features of a target video frame.

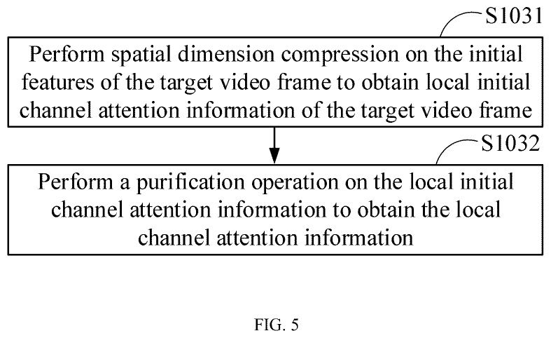

The target video frame is one of the video frames in the video sequence. Referring to FIG. 5, in one embodiment, step S103 may include the following steps.
Step S1031: Perform spatial dimension compression on the initial features of the target video frame to obtain local initial channel attention information of the target video frame.

Specifically, the t-th video frame in the video sequence can be used as the target video frame, that is, the target video frame can be denoted by Iₜ. For the initial feature Fₜ of the target video frame Iₜ, spatial dimension compression can be performed on the initial feature Fₜ, as shown in FIG. 4, to obtain the local initial channel attention information fₜ of the target video frame Fₜ.

It can be understood that the dimension of the initial feature Fₜ is H×W×C. For each feature channel C, its corresponding two-dimensional feature with dimension H×W can be obtained. In one embodiment, spatial dimension compression can be performed on the two-dimensional features with the dimension H×W corresponding to each feature channel to obtain the two-dimensional features with the dimension 1×1. Finally, the local initial channel attention information fi with the dimension of 1×1×C as shown in FIG. 4 can be obtained.

Specifically, a global average pooling operation can be performed on the initial features Fₜ of the target video frame Iₜ to obtain the local initial channel attention information fₜ of the target video frame Iₜ. The specific calculation equation can be as follows:

$${f}_{t} = \frac{1}{H \times W} {\sum }_{h = 1}^{H} {\sum }_{w = 1}^{W} {F}_{{t}_{h , w}} ,$$

where Fₜ_{_{h,w}} is the two-dimensional feature corresponding to the initial feature in feature channel C. According to the equation above, the local initial channel attention information of the target video frame can be obtained.
Step S1032: Perform a purification operation on the local initial channel attention information to obtain the local channel attention information.

In one embodiment, after obtaining the local initial channel attention information of the target video frame, a purification operation can be performed on the local initial channel attention information to obtain the local channel attention information.

Specifically, a preset first fully connected layer for purifying local initial channel attention information can be employed to perform dimensionality reduction processing on the local initial channel attention information to obtain local dimensionally reduced channel attention information. After that, a preset second fully connected layer for purifying the local initial channel attention information can be employed to perform dimensionality enhancement processing on the local dimensionality reduction channel attention information to obtain the local channel attention information. In one embodiment, the purification operation can be expressed by the following equation: \hat{f}ₜ=W₂(W₁fₜ), where \hat{f}ₜ represents the local channel attention information of the target video frame, W₁ and W₂ represent the first purification coefficient and the second purification coefficient of the local initial channel attention information, respectively. W₁ and W₂ can respectively represent the dimensionality reduction and dimensionality enhancement performed on the local initial channel attention information.

In one embodiment, after the fully connected layer, a preset activation function can be employed to activate the obtained channel attention information. For example, a preset first activation function can be employed after the first fully connected layer, and a preset second activation function can also be employed after the second fully connected layer. The activation function can be set according to actual needs. For example, it can be a common activation function such as a Sigmoid activation function or a Swish activation function.
Step S104: Perform channel attention mechanism processing on the initial features of the target video frame according to the global channel attention information and the local channel attention information to obtain optimized features of the target video frame.

It can be understood that after obtaining the global channel attention information and local channel attention information, channel attention mechanism processing can be performed on the initial features of the target video frame to obtain the optimized features of the target video frame according to the global channel attention information and local channel attention information.

In one embodiment, the global channel attention information and the local channel attention information can be fused to obtain the fused channel attention information of the target video frame. The process of fusion processing can be set according to actual needs, and the present disclosure does not impose restrictions on this. For example, the fusion process may be to average the global channel attention information and local channel attention information to obtain the fused channel attention information of the target video frame.

After the fused channel attention information is obtained, channel attention mechanism processing can be performed on the initial features of the target video frame to obtain the optimized features of the target video frame.

It can be understood that the dimension of the fused channel attention information is 1×1×C, that is, for each feature channel, the corresponding channel attention information with the dimension of 1×1 can be obtained. In one embodiment, channel attention information with a dimension of 1×1 corresponding to each feature channel can be used to perform attention mechanism processing on the two-dimensional feature of the initial feature Fₜ of the target video frame with a dimension of H×W on the corresponding feature channel. Through the approach above, the fusion channel attention information and the initial features Fₜ of the target video frame can be multiplied on a feature channel-by-feature channel basis to obtain the optimized features of the target video frame as shown in FIG. 4. In one embodiment, the fusion processing and channel attention mechanism processing process can refer to the following equation:

$${\hat{F}}_{t} = {F}_{t} ⊗ \frac{1}{2} \times ( {\hat{f}}_{t} + {\hat{f}}_{t}^{global} ) ,$$

where \hat{F}ₜ represents the optimized feature of the target video frame

$${I}_{t} , \frac{1}{2} \times ( {\hat{f}}_{t} + {\hat{f}}_{t}^{global} )$$

represents the fused channel attention information obtained by fusion processing of global channel attention information and local channel attention information, ⊗ represents a feature channel-by-feature channel multiplication operation.

In one embodiment, by traversing the video frames in the video sequence, the optimization features corresponding to each target video frame can be obtained. That is, the optimized features of each video frame in the entire video sequence can be obtained. Then, the optimized features of each video frame can be used for subsequent video learning, classification and other tasks.

By implementing the method described above, the local information of a single video frame and the global information of the video sequence can be used simultaneously to perform channel attention mechanism processing on the initial features to obtain optimized features. This can fully integrate the local information and global information of the video frame, making the optimized features of the video frame better interpretable, thus improving the robustness of the video frame feature extraction method.

It should be understood that sequence numbers of the foregoing processes do not mean particular execution sequences. The execution sequences of the processes should be determined based on functions and internal logic of the processes, and should not be construed as any limitation on the implementation processes of the embodiments of the present disclosure.

Referring to FIG. 6, in one embodiment, a video frame feature extraction device may include an initial feature acquisition module 501, a global channel attention information calculation module 502, a local channel attention information calculation module 503, and a channel attention mechanism processing module 504.

The initial feature acquisition module 501 is to obtain a number of initial features of each video frame in a video sequence. The global channel attention information calculation module 502 is to calculate global channel attention information of the video sequence based on the initial features of each video frame in the video sequence. The local channel attention information calculation module 503 is to calculate local channel attention information of a target video frame according to initial features of a target video frame. The target video frame is one of the video frames in the video sequence. The channel attention mechanism processing module 504 is to perform channel attention mechanism processing on the initial features of the target video frame according to the global channel attention information and the local channel attention information to obtain optimized features of the target video frame.

In one embodiment, the global channel attention information calculation module 502 may include a fusion processing unit, a spatial dimension compression unit, and a purification operation unit. The fusion processing unit is to perform fusion processing on the initial features of each video frame in the video sequence to obtain the global initial features of the video sequence. The spatial dimension compression unit is to perform spatial dimension compression on the global initial features to obtain global initial channel attention information of the video sequence. The purification operation unit is to perform a purification operation on the global initial channel attention information to obtain the global channel attention information.

In one embodiment, the spatial dimension compression unit may include a two-dimensional feature acquisition subunit and a spatial dimension compression subunit. The two-dimensional feature acquisition subunit is to obtain two-dimensional features corresponding to each feature channel in the global initial features. The spatial dimension compression subunit is to perform spatial dimension compression on the two-dimensional features corresponding to each feature channel to obtain the global initial channel attention information.

In one embodiment, the purification operation unit may include a dimensionality reduction processing subunit and a dimensionality enhancement processing subunit. The dimensionality reduction processing subunit is to perform dimensionality reduction processing on the global initial channel attention information using a preset first fully connected layer to obtain global dimensionality reduction channel attention information. The dimensionality enhancement processing subunit is to perform dimensionality enhancement processing on the global dimensionality reduction channel attention information using a preset second fully connected layer to obtain the global channel attention information.

In one embodiment, the local channel attention information calculation module 503 may include a spatial dimension compression unit and a purification operation unit. The spatial dimension compression unit is to perform spatial dimension compression on the initial features of the target video frame to obtain local initial channel attention information of the target video frame. The purification operation unit is to perform a purification operation on the local initial channel attention information to obtain the local channel attention information.

In one embodiment, the channel attention mechanism processing module 504 may include a fusion processing unit and a channel attention mechanism processing unit. The fusion processing unit is to perform fusion processing on the global channel attention information and the local channel attention information to obtain the fused channel attention information of the target video frame. The channel attention mechanism processing unit is to perform channel attention mechanism processing on the initial features of the target video frame to obtain optimized features of the target video frame according to the fused channel attention information.

In one embodiment, the channel attention mechanism processing unit may include a channel attention information acquisition subunit and a channel attention mechanism processing subunit. The channel attention information acquisition subunit is to obtain channel attention information corresponding to each feature channel in the fused channel attention information. The channel attention mechanism processing subunit is to perform channel attention mechanism processing on the initial features of the target video frame using the channel attention information corresponding to each feature channel to obtain the optimized features of the target video frame.

It should be noted that content such as information exchange between the modules/units and the execution processes thereof is based on the same idea as the method embodiments of the present disclosure, and produces the same technical effects as the method embodiments of the present disclosure. For the specific content, refer to the foregoing description in the method embodiments of the present disclosure. Details are not described herein again.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for extracting video frame features, the method comprising:
obtaining a plurality of initial features of each video frame in a video sequence;
calculating global channel attention information of the video sequence based on the plurality of initial features of each video frame in the video sequence;
calculating local channel attention information of a target video frame according to initial features of a target video frame; wherein the target video frame is one of the video frames in the video sequence; and
performing channel attention mechanism processing on the initial features of the target video frame according to the global channel attention information and the local channel attention information to obtain optimized features of the target video frame.

2. The method of claim 1, wherein calculating global channel attention information of the video sequence based on the plurality of initial features of each video frame in the video sequence comprises:
performing fusion processing on the initial features of each video frame in the video sequence to obtain the global initial features of the video sequence;
performing spatial dimension compression on the global initial features to obtain global initial channel attention information of the video sequence; and
performing a purification operation on the global initial channel attention information to obtain the global channel attention information.

3. The method of claim 2, wherein performing spatial dimension compression on the global initial features to obtain global initial channel attention information of the video sequence comprises:
obtaining two-dimensional features corresponding to each feature channel in the global initial features; and
performing spatial dimension compression on the two-dimensional features corresponding to each feature channel to obtain the global initial channel attention information.

4. The method of claim 2, wherein performing a purification operation on the global initial channel attention information to obtain the global channel attention information comprises:
performing dimensionality reduction processing on the global initial channel attention information using a preset first fully connected layer to obtain global dimensionality reduction channel attention information; and
performing dimensionality enhancement processing on the global dimensionality reduction channel attention information using a preset second fully connected layer to obtain the global channel attention information.

5. The method of claim 1, wherein calculating local channel attention information of the target video frame according to initial features of the target video frame comprises:
performing spatial dimension compression on the initial features of the target video frame to obtain local initial channel attention information of the target video frame; and
performing a purification operation on the local initial channel attention information to obtain the local channel attention information.

6. The method of claim 1, wherein performing channel attention mechanism processing on the initial features of the target video frame according to the global channel attention information and the local channel attention information to obtain optimized features of the target video frame comprises:
performing fusion processing on the global channel attention information and the local channel attention information to obtain the fused channel attention information of the target video frame; and
performing channel attention mechanism processing on the initial features of the target video frame to obtain optimized features of the target video frame according to the fused channel attention information.

7. The method of claim 6, wherein performing channel attention mechanism processing on the initial features of the target video frame to obtain optimized features of the target video frame according to the fused channel attention information comprises:
obtaining channel attention information corresponding to each feature channel in the fused channel attention information; and
performing channel attention mechanism processing on the initial features of the target video frame using the channel attention information corresponding to each feature channel to obtain the optimized features of the target video frame.

8. A device for extracting video frame features comprising:
one or more processors; and
a memory coupled to the one or more processors, the memory storing programs that, when executed by the one or more processors, cause performance of operations comprising:
obtaining a plurality of initial features of each video frame in a video sequence;
calculating global channel attention information of the video sequence based on the plurality of initial features of each video frame in the video sequence;
calculating local channel attention information of a target video frame according to initial features of a target video frame; wherein the target video frame is one of the video frames in the video sequence; and
performing channel attention mechanism processing on the initial features of the target video frame according to the global channel attention information and the local channel attention information to obtain optimized features of the target video frame.

9. The device of claim 8, wherein calculating global channel attention information of the video sequence based on the plurality of initial features of each video frame in the video sequence comprises:
performing fusion processing on the initial features of each video frame in the video sequence to obtain the global initial features of the video sequence;
performing spatial dimension compression on the global initial features to obtain global initial channel attention information of the video sequence; and
performing a purification operation on the global initial channel attention information to obtain the global channel attention information.

10. The device of claim 9, wherein performing spatial dimension compression on the global initial features to obtain global initial channel attention information of the video sequence comprises:
obtaining two-dimensional features corresponding to each feature channel in the global initial features; and
performing spatial dimension compression on the two-dimensional features corresponding to each feature channel to obtain the global initial channel attention information.

11. The device of claim 9, wherein performing a purification operation on the global initial channel attention information to obtain the global channel attention information comprises:
performing dimensionality reduction processing on the global initial channel attention information using a preset first fully connected layer to obtain global dimensionality reduction channel attention information; and
performing dimensionality enhancement processing on the global dimensionality reduction channel attention information using a preset second fully connected layer to obtain the global channel attention information.

12. The device of claim 8, wherein calculating local channel attention information of the target video frame according to initial features of the target video frame comprises:
performing spatial dimension compression on the initial features of the target video frame to obtain local initial channel attention information of the target video frame; and
performing a purification operation on the local initial channel attention information to obtain the local channel attention information.

13. The device of claim 8, wherein performing channel attention mechanism processing on the initial features of the target video frame according to the global channel attention information and the local channel attention information to obtain optimized features of the target video frame comprises:
performing fusion processing on the global channel attention information and the local channel attention information to obtain the fused channel attention information of the target video frame; and
performing channel attention mechanism processing on the initial features of the target video frame to obtain optimized features of the target video frame according to the fused channel attention information.

14. The device of claim 13, wherein performing channel attention mechanism processing on the initial features of the target video frame to obtain optimized features of the target video frame according to the fused channel attention information comprises:
obtaining channel attention information corresponding to each feature channel in the fused channel attention information; and
performing channel attention mechanism processing on the initial features of the target video frame using the channel attention information corresponding to each feature channel to obtain the optimized features of the target video frame.

15. A non-transitory computer-readable storage medium storing instructions that, when executed by at least one processor of a device, cause the at least one processor to perform a method, the method comprising:
obtaining a plurality of initial features of each video frame in a video sequence;
calculating global channel attention information of the video sequence based on the plurality of initial features of each video frame in the video sequence;
calculating local channel attention information of a target video frame according to initial features of a target video frame; wherein the target video frame is one of the video frames in the video sequence; and
performing channel attention mechanism processing on the initial features of the target video frame according to the global channel attention information and the local channel attention information to obtain optimized features of the target video frame.

16. The non-transitory computer-readable storage medium of claim 15, wherein calculating global channel attention information of the video sequence based on the plurality of initial features of each video frame in the video sequence comprises:
performing fusion processing on the initial features of each video frame in the video sequence to obtain the global initial features of the video sequence;
performing spatial dimension compression on the global initial features to obtain global initial channel attention information of the video sequence; and
performing a purification operation on the global initial channel attention information to obtain the global channel attention information.

17. The non-transitory computer-readable storage medium of claim 16, wherein performing spatial dimension compression on the global initial features to obtain global initial channel attention information of the video sequence comprises:
obtaining two-dimensional features corresponding to each feature channel in the global initial features; and
performing spatial dimension compression on the two-dimensional features corresponding to each feature channel to obtain the global initial channel attention information.

18. The non-transitory computer-readable storage medium of claim 16, wherein performing a purification operation on the global initial channel attention information to obtain the global channel attention information comprises:
performing dimensionality reduction processing on the global initial channel attention information using a preset first fully connected layer to obtain global dimensionality reduction channel attention information; and
performing dimensionality enhancement processing on the global dimensionality reduction channel attention information using a preset second fully connected layer to obtain the global channel attention information.

19. The non-transitory computer-readable storage medium of claim 15, wherein calculating local channel attention information of the target video frame according to initial features of the target video frame comprises:
performing spatial dimension compression on the initial features of the target video frame to obtain local initial channel attention information of the target video frame; and
performing a purification operation on the local initial channel attention information to obtain the local channel attention information.

20. The non-transitory computer-readable storage medium of claim 15, wherein performing channel attention mechanism processing on the initial features of the target video frame according to the global channel attention information and the local channel attention information to obtain optimized features of the target video frame comprises:
performing fusion processing on the global channel attention information and the local channel attention information to obtain the fused channel attention information of the target video frame; and
performing channel attention mechanism processing on the initial features of the target video frame to obtain optimized features of the target video frame according to the fused channel attention information.
